(19) United States
(12) Patent Application Publication
(10) Pub. No.: US 2024/0192713 A1
(43) Pub. Date: Jun. 13, 2024

(54) Method and System for Effective Handling of Reverse Power Flow for On-Load Tap Changer Controller

(71) Applicant: ABB Schweiz AG, Baden (CH)

(72) Inventors: Simi Valsan, Ernakulam (IN); Arinjai Gupta, Bengaluru (IN)

(73) Assignee: ABB Schweiz AG, Baden (CH)

(21) Appl. No.: 18/582,853

(22) Filed: Feb. 21, 2024

Related U.S. Application Data
(63) Continuation of application No. PCT/IB2021/060312, filed on Nov. 8, 2021.

(51) Int. Cl. G05F 1/14; H01F 29/04

(52) U.S. Cl. CPC G05F 1/14; H01F 29/04

(57) ABSTRACT

A method and a system for controlling an on-load tap changer of a transformer during reverse power flow includes determining a loss ratio factor using voltage and current values for each of a primary side and a secondary side of a transformer. Further, the method comprises determining a relative strength of a first source connected to the primary side and a second source connected to the secondary side of the transformer based on the loss ratio factor. Thereafter, transmitting a control signal to an on-load tap changer of the transformer to regulate voltage on the primary side or on the secondary side of the transformer based on the relative strength of the first source and the second source.

### CROSS-REFERENCE TO RELATED APPLICATIONS

The instant application claims priority to International Patent Application No. PCT/IB2021/060312, filed Nov. 8, 2021, which is incorporated herein in its entirety by reference.

### FIELD OF THE DISCLOSURE

The present disclosure generally relates to protection and control in power systems and, more particularly, to a method and system for effective handling of reverse power flow for an On-Load Tap changer (OLTC) of a transformer.

### BACKGROUND OF THE INVENTION

Conventionally, power flow in a distribution feeder was unidirectional, i.e., from stronger source to weaker source. With the increased penetration of renewable energy generation on the distribution feeders, it is very common that power flows in a reverse direction to substation. The reverse power flow occurs as utilities and houses generate power using renewable resources such as solar energy. Traditionally, it is assumed that power flows from higher voltage side (primary of a transformer) to lesser voltage side (secondary of the transformer) and it is required to keep the secondary side voltage constant despite of load current and primary side voltage variations. This is achieved by monitoring the secondary side voltage and controlling a tap changer position accordingly. Increasing the primary winding turns will lower the secondary side voltage and vice versa.

When the power flows in the reverse direction, effectiveness of the voltage regulation depends on the relative strengths of the sources on either side of the transformer. Voltage regulation of the transformer is effective only if it is performed on relatively weaker source side. Hence, it is important to determine the relative strength of sources on either side of the transformer. Few existing transformer voltage regulation systems do not regulate both sides of the transformer based on the direction of the power flow. Such a system can cause deterioration of the voltage as the correct side of the transformer is not regulated. Few other transformer voltage regulation systems rely on impedance-based methods which have complex calculations in determining the side to be regulated. Also, required parameters are not always available. Hence, there is a need for a simple solution that determines the transformer side to be regulated in real-time.

The information disclosed in this background of the disclosure section is only for enhancement of understanding of the general background of the invention and should not be taken as an acknowledgement or any form of suggestion that this information forms the prior art already known to a person skilled in the art.

### BRIEF SUMMARY OF THE INVENTION

In an embodiment, the present disclosure discloses a method of effective handling of reverse power flow for an on-load tap changer of a transformer when power flowing through the transformer reverses. The method comprises determining a loss ratio factor using voltage and current values for each of a primary side and a secondary side of a transformer. Further, the method comprises determining a relative strength of a first source connected to the primary side and a second source connected to the secondary side of the transformer based on the loss ratio factor. Thereafter, transmitting a control signal to an on-load tap changer of the transformer to regulate voltage on the primary side or on the secondary side of the transformer based on the relative strength of the first source and the second source.

In an embodiment, the present disclosure discloses a system for effective handling of reverse power flow for an on-load tap changer of a transformer. The system comprises a memory and one or more processors. The one or more processors are configured to determine a loss ratio factor using voltage and current values for each of a primary side and a secondary side of a transformer. Further, the one or more processors are configured to determine a relative strength of a first source connected to the primary side and a second source connected to the secondary side of the transformer based on the loss ratio factor. Thereafter, the one or more processors are configured to transmit a control signal to an on-load tap changer of the transformer to regulate voltage on the primary side or on the secondary side of the transformer based on the relative strength of the first source and the second source.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE SEVERAL VIEWS OF THE DRAWING(S)

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements.

FIG. 1A illustrates a simplified diagram of a power system, in accordance with some embodiments of the present disclosure.

FIG. 1B illustrates a single line diagram of a power system, in accordance with some embodiments of the present disclosure.

FIG. 2 shows a diagram illustrating connection of a system with a transformer of a power system, in accordance with some embodiments of the present disclosure.

FIG. 3 shows a block diagram of a system, in accordance with some embodiments of the present disclosure.

FIG. 4. shows an exemplary flow chart illustrating method steps for controlling an OLTC, in accordance with some embodiments of the present disclosure.

FIG. 5A-5D illustrate controlling the OLTC in different conditions, in accordance with some embodiments of the present disclosure.

FIGS. 6A and 6B illustrates difference in transformer voltage between conventional system and current system, in accordance with some embodiments of the present disclosure.

FIG. 7 shows a block diagram of a general-purpose computing system for controlling an OLTC, in accordance with embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION OF THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular form disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

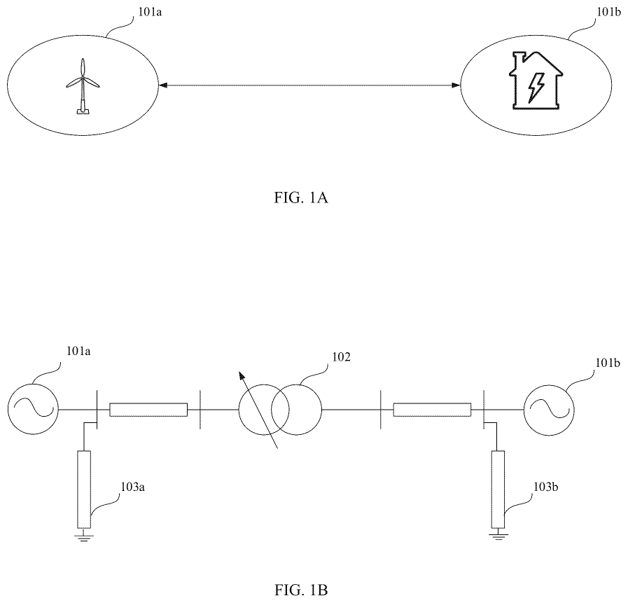

FIG. 1A illustrates a simplified power system. The power system comprises a first source 101a and a second source 101b. The first source 101a may include a power generation plant, a substation, and the like, and the second source 101b may include a utility grid, industrial or residential buildings. In an embodiment, power may flow from the first source 101a to the second source 101a. In another embodiment, the power may flow from the second source 101b to the first source 101a. In a typical scenario the first source 101a is stronger than the second source 101b. A strong source may be defined as a source having low voltage deviations and a weak source may be defined as a source having high voltage deviations. A person skilled will appreciate that the strong source and the weak source are defined using other parameters as well such as stability, frequency fluctuations, fault currents and the like. The first source 101a and the second source 101b are connected via a feeder line. For example, a feeder line is connected between a utility grid and a substation.

FIG. 1B illustrates a single line diagram of the power system. As seen, the first source 101a is connected to a primary of a transformer 102 and the second source 101b is connected to a secondary of the transformer 102. In an embodiment, the transformer 102 is a three-phase transformer. The transformer 102 is used to regulate the voltage that is transferred between the first source 101a and the second source 101b. Generally, voltage regulation is performed using an On-Load Tap Changer (OLTC) (not shown). OLTC is a device for changing tapping connections of a winding of the transformer 102. The OLTC can increase or decrease primary side and secondary side voltage of the transformer 102 depending on the power system operating conditions. The OLTC operates while the power system is not interrupted. The OLTC may include a selector switch that is used to select different taps. Further, the OLTC may include an OLTC controller that is configured to control the taps of the OLTC. The first source 101a and the second source 101b are connected to respective loads 103a, 103b.

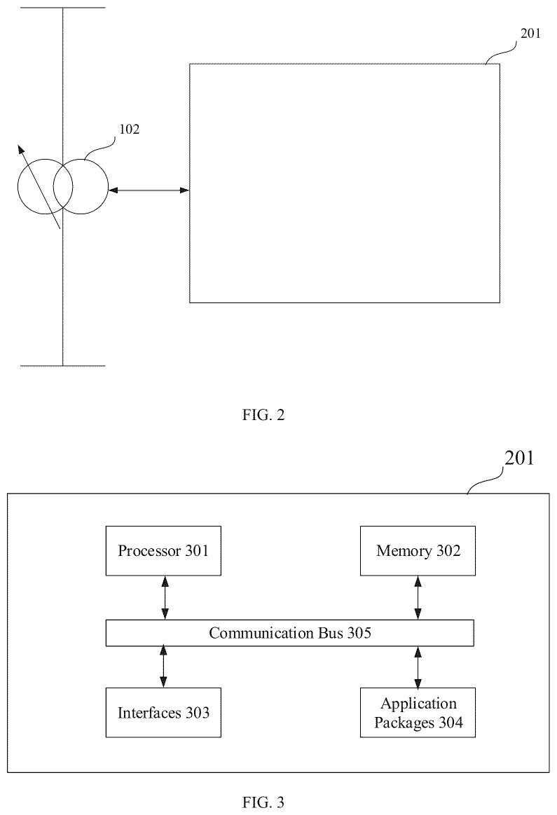

FIG. 2 shows a diagram illustrating connection of a system 201 with the transformer 102 of the power system. In an embodiment, the system 201 is configured for protection and control of the transformer 102. The system 201 is further configured for operating the OLTC to control voltage of the transformer 102. The system 201 may be electrically and communicatively connected to the transformer. In an embodiment, the system 201 receives voltage and current measurements from the transformer 102. Based on the measurements, the system 201 determines if the transformer voltage needs to be increased or decreased. In an embodiment, two or more transformers may be connected to the system 201. The system 201 may receive the measurements from the transformer 102 via an Ethernet bus according to IEC61850 standards. One or more Current Transformers (CT) and Voltage Transformers (VT) measure the primary and secondary current and voltage of the transformer 102. The system 201 may also receive OLTC position. The OLTC position may be obtained as analog signals or digital signals as a measure of current values or resistance values or binary coded signal or GOOSE signals. The current or resistance measure can then be converted to integer value. The system 201 may be a protection relay or a general-purpose computing system. The system 201 may be part of a SCADA or DCS. The system 201 may be connected to other computing systems via a process bus and use GOOSE messaging to exchange data.

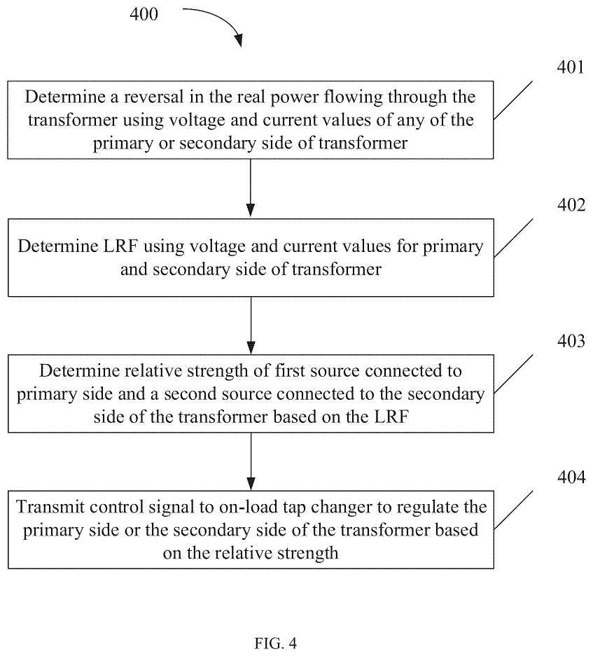

FIG. 3 shows a block diagram of the system 201, in accordance with some embodiments of the present disclosure. The system 201 includes one or more processors 301, a memory 302, one or more interfaces 303, one or more application packages 304 and a communication bus 305. The one or more processors 301 are configured to execute the one or more application functions 304. The one or more application packages 304 may include, but are not limited to, OLTC control and monitoring, transformer protection, condition monitoring and supervision, control and indication and the like. The OLTC control and monitoring application package may include a plurality of functions including a tap position monitor function, a transformer monitor function, a power reversal detecting function, a Loss Ratio Factor (LRF) function, source strength determination function and a tap position control function.

The tap position monitoring function is configured to monitor the OLTC position. As described before, the OLTC position is obtained as a measure of current values or resistance values or binary coded signals or GOOSE signals. The values are then converted to integer values to determine the position of the OLTC. In case of GOOSE signals, tap position may be measured by other participating systems and the tap position is provided as GOOSE signal to the system 201. The position of the OLTC tap may be monitored periodically, for example, every 100 ms.

The transformer monitoring function is configured to monitor if the voltage values and the current values of the primary and the secondary of the transformer 102 are within predefined bands. The transformer monitoring function receives the current values and the voltage values from the CT and the VT of the transformer 102. As described, the CT and the VT may provide the current values and the voltage values via the Ethernet bus (also referred as process bus). In an embodiment, the CT values and the VT values may be provided as analog signals or digital signals.

The LRF function is configured to determine the LRF using the voltage values and the current values for each of the primary side and the secondary side of the transformer 102 once a reversal in power flowing through the transformer is detected. The source strength determination function is configured to determine a relative strength between the first source 101a and the second source 101b using the LRF. The relative strength is used to determine which side of the transformer 102 must be regulated. The tap position control function is configured to generate a control signal for regulating one of the primary side or the secondary side of the transformer 102.

In an embodiment, the transformer protection application package may include functions for protecting the transformer from different faults. For example, the transformer protection application package may include, but not limited to an overcurrent protection function, an overcurrent protection function, short circuit protection function, earth fault protection function, thermal protection function, dielectric protection function and mechanical stress protection function. The transformer protection application package may be configured to operate one or more circuit breakers to protect the transformed from being damaged in case of faults.

The condition monitoring and supervision application package may include various functions for monitoring condition of the transformer 102. For example, the condition monitoring and supervision application package may include thermal monitoring function, voltage and current monitoring function, earth fault monitoring function and the like. In an embodiment, the condition monitoring and supervision application package may obtain various parameters from the transformer 102 and supervise the parameters to determine if the parameters are within predefined bands.

The control and indication application package may be configured to provide alarms and indications upon detecting faults. Also, the control and indication application package may be associated with a Local Human Machine Interface (LHMI) or a remote HMI for indicating status messages and alerts.

In an embodiment, the one or more interfaces 303 may include Ethernet and/or serial interfaces. The one or more interfaces facilitates communication between the system 101 and other components of the power system. The one or more interfaces 303 may support different communication protocols such as Modbus, IEC 60870, IEC 61850 and the like.

In an embodiment, the memory 302 may include disturbance and fault recorders, event recorder, logical and mathematical functions, web HMI.

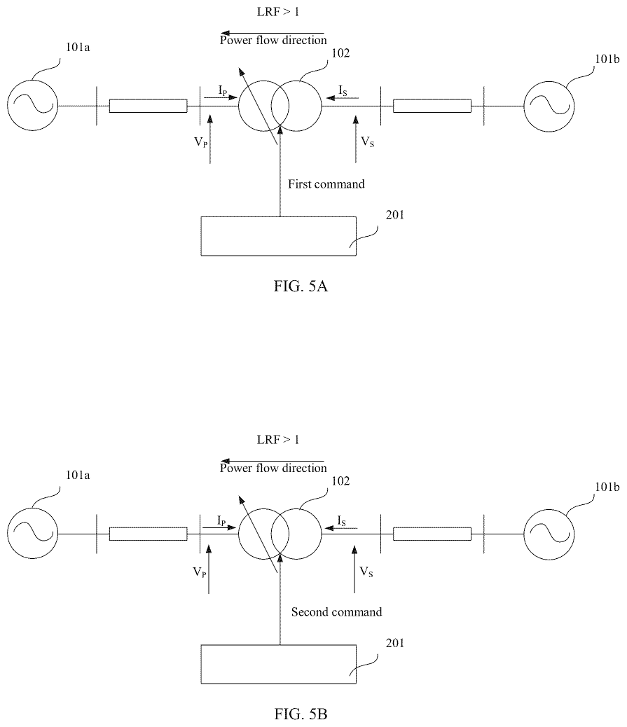

FIG. 4 shows an exemplary flow chart illustrating method steps for controlling an OLTC, in accordance with some embodiments of the present disclosure. The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 401, the power reversal detection function detects a reversal in the real component of the power flowing through the transformer 102 using the current values and voltage values of any of the primary side or secondary side of the transformer 102. The real component of the power flowing through the transformer 102 can be determined for the primary side P_{P} or secondary side P_{S} as:

P_{P}=V_{P}*I_{P}*cos(Ø_{P}) (1)

P_{S}=V_{S}*I_{S}*cos(Ø_{S}) (2)

where, V_{P} is the primary side voltage magnitude, V_{S} is the secondary side voltage magnitude, I_{P} is the primary side current magnitude, I_{S} is the secondary side current magnitude, Ø_{P} is the angle between primary side voltage and current, and Ø_{S} is the angle between secondary side voltage and current.

At step 402, the LRF function determines the LRF using the current values and the voltage values of the primary side and the secondary side of the transformer 102 when a reversal in power flow is detected by step 401. The LRF obtains the current values and the voltage values of the primary side and the secondary side of the transformer 102 from the transformer monitoring function. The current values and the voltage values can be used to determine components of apparent power at the primary side and secondary side of the transformer 102. The components of the apparent power are indicated as S_{P} and S_{S}, where S_{P} is the apparent power component at the primary of the transformer 102 and S_{S} is the apparent power component at the secondary of the transformer 102. S_{P} and S_{S} are represented as:

S_{P}=S_{1Load}+S_{1Loss} (3)

S_{S}=S_{2Load}+S_{2Loss} (4)

where S_{1Loss} and S_{2Loss} are the contributions from the first source 101a and the second source 101b towards the loss in the transformer 102, and the S_{1Load} and the S_{2Load} are the first load 103a and the second load 103b connected to respective sources. Using the equation (3) and the equation (4), the LRF can be calculated as below:

$$\\ \begin{matrix}L R F = \frac{\vert {S}_{S} \vert}{\vert {S}_{P} \vert} = \frac{\vert {S}_{2 Load} + {S}_{2 Loss} \vert}{\vert {S}_{1 Load} + {S}_{1 Loss} \vert} = \frac{\vert {V}_{S 1} \vert * \vert {I}_{S 1} \vert}{\vert {V}_{P 1} \vert * \vert {I}_{P 1} \vert} & ( 5 )\end{matrix}$$

where, V_{P1}, I_{P1}, V_{S1} and I_{S1} are the positive sequence voltages and currents on the primary and secondary sides of the transformer 102. As given in the equation (5), the LRF is calculated as a ratio of the voltage and current values of the secondary side of the transformer 102 to the voltage and current values of the primary side of the transformer 102.

In an embodiment, when one of the primary or the secondary side current values and the voltage values are not available, the values can be estimated using the available current values and the voltage values. For example, when secondary side current values and the voltage values are available, the primary side current values and the voltage values can be estimated using the below equations:

$$\\ \begin{matrix}{V}_{P} = \{ 1 + ( TAP\_POS - TAP\_NOM ) * Δ {V}_{step} \} * \{ {V}_{S} - {I}_{S} * ZV \} & ( 6 )\end{matrix}$$

$$\\ \begin{matrix}{I}_{P} = \frac{{I}_{S}}{\{ 1 + ( TAP\_POS - TAP\_NOM ) * Δ {V}_{step} \}} & ( 7 )\end{matrix}$$

where V_{P} is the Primary side estimated voltage, I_{P} is the Primary side estimated current, V_{S} is the Secondary side measured voltage, I_{S} is the Secondary side measured current, TAP_NOM is the Nominal tap, TAP_POS is the Present tap position, ΔVₛₜₑₚ is the Step of Tap, and ZV is the Impedance voltage referred to secondary side

At step 403, the strength determination function determines a relative strength of the first source 101a connected to the primary side and the second source 101b connected to the secondary side of the transformer 102 based on the LRF. The strength determination function obtains the LRF from the LRF function. The LRF is either lesser than 1 or greater than 1. The LRF being lesser than 1 indicates that the first source 101a supports a higher share of the total losses, when the power flow in from the second source 101b towards the first source 101a, thereby indicating that source 101a is stronger in relation to source 101b, and the regulation should be performed on the secondary side of the transformer 102. The LRF being greater than 1 indicates that the second source 101b supports a higher share of the total losses, when the power flow in from the second source 101b towards the first source 101a, thereby indicating that source 101b is stronger in relation to source 101a, and the regulation should be performed on the primary side of the transformer 102. Therefore, the strength determination function determines that the strength of the second source 101b is higher than the strength of the first source 101a, when the LRF is greater than 1, and the strength of the first source 101a is higher than the strength of the second source 101b, when the LRF is lesser than 1.

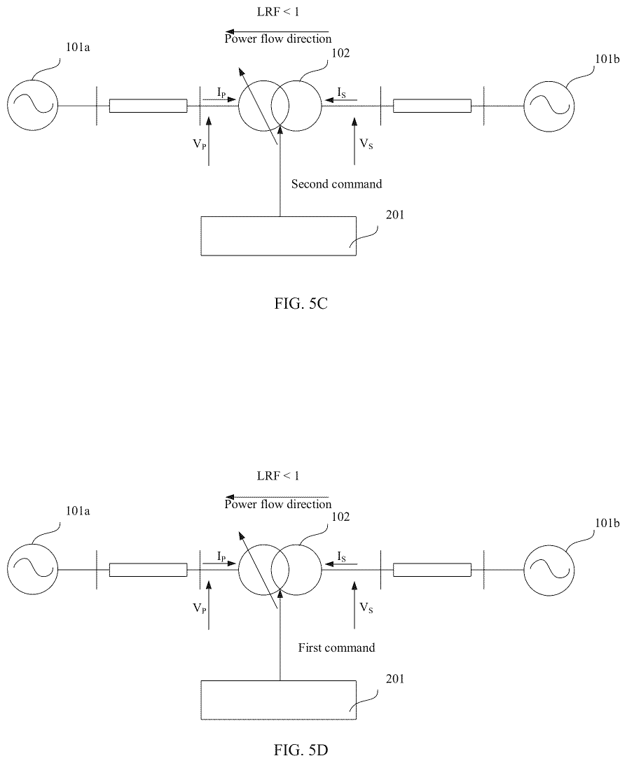

At step 404, the tap position control function transmits a control signal to the OLTC to regulate the primary side or the secondary side of the transformer based on the relative strength of the first source 101a and the second source 101b. Transmitting the control signal may include transmitting a first command or transmitting a second command. For example, the first command may be a raise command and the second command may be a lower command. The first command may raise the tap position of the OLTC, thus increasing the windings on the primary of the transformer 102. The lower command may lower the tap position, thus decreasing the windings on the primary side of the transformer 102. The first command and the second command are determined based on the voltage and current values of each of the primary side and the secondary side of the transformer 102. In an embodiment, the first command causes the OLTC to increase primary side windings of the transformer 102 when the voltage value on the primary side is less than a predefined voltage band and the LRF is greater than 1. In an embodiment, the second command causes the OLTC to decrease the primary side windings of the transformer 102 when the voltage on the primary side is more than the predefined voltage band and the LRF is greater than 1. In an embodiment, the second command causes the OLTC to decrease primary side windings of the transformer when the voltage value on the secondary side is less than a predefined voltage band and the LRF is less than 1. In an embodiment, the first command causes the OLTC to increase the primary side windings of the transformer 102 when the voltage on the secondary side is more than the predefined voltage band and the LRF is less than 1. The different conditions are illustrated with the help of FIG. 5A-FIG. 5D.

Condition 1: Reverse power flow and LRF>1 and primary side voltage<predefined voltage band. FIG. 5A illustrates the condition 1. As shown in FIG. 5A, the power is flowing in reverse direction form source 101b to 101a and the LRF is greater than 1, thus the second source 101b is a stronger source compared to the first source 101a. It is assumed that by default the power flow is from the first source 101a to the second source 101b, and the secondary side of the transformer 102 is generally regulated. In the condition 1, since the power flow is reversed and as the second source 101b is a stronger source, the primary side of the transformer 102 must be regulated. However, the primary side of the transformer 102 is not regulated when the voltage values of the primary side is within the predefined voltage band. When the voltage values of the primary side of the transformer 102 is less than the predefined voltage band, the first command or the raise command is transmitted by the system 201 to the OLTC. The OLTC controller receives the first command and increases the tap position. Increasing the tap position increases the windings on the primary side, therefore increasing the voltage on the primary side. In one embodiment, the number of taps to be increased may be based on the current tap position and the deviation of the primary side voltage from the predefined threshold value.

Condition 2: Reverse power flow and LRF>1 and primary side voltage>predefined voltage band. FIG. 5B illustrates the condition 2. As shown in FIG. 5B, the power is flowing in reverse direction form source 101b to 101a and the LRF is greater than 1, thus the second source 101b is a stronger source compared to the first source 101a. In the condition 2, since the power flow is reversed and as the second source 101b is a stronger source, the primary side of the transformer 102 must be regulated when the voltage values of the primary side is greater than the predefined voltage band. That is, when the voltage values of the primary side of the transformer 102 is greater than the predefined voltage band, the second command or the lower command is transmitted by the system 201 to the OLTC. The OLTC controller receives the second command and decreases the tap position. Decreasing the tap position decreases the windings on the primary side, therefore decreasing the voltage on the primary side. In one embodiment, the number of taps to be decreased may be based on the current tap position and the deviation of the primary side voltage from the predefined threshold value.

Condition 3: Reverse power flow and LRF<1 and secondary side voltage<predefined voltage band. FIG. 5C illustrates the condition 3. As shown in FIG. 5C, the power is flowing in reverse direction form source 101b to 101a and the LRF is less than 1, thus the first source 101a is a stronger source compared to the second source 101b. In the condition 3, since the power flow is reversed and as the first source 101a is a stronger source, the secondary side of the transformer 102 must be regulated when the voltage values of the secondary side is less than the predefined voltage band. That is, when the voltage values of the secondary side of the transformer 102 is less than the predefined voltage band, the second command or the lower command is transmitted by the system 201 to the OLTC. The OLTC controller receives the second command and decreases the tap position. Decreasing the tap position decreases the windings on the primary side, therefore increasing the voltage on the secondary side. In one embodiment, the number of taps to be decreased may be based on the current tap position and the deviation of the secondary side voltage from the predefined threshold value.

Condition 4: Reverse power flow and LRF<1 and secondary side voltage>predefined voltage band. FIG. 5D illustrates the condition 4. As shown in FIG. 5D, the power is flowing in reverse direction form source 101b to 101a and the LRF is less than 1, thus the first source 101a is a stronger source compared to the second source 101b. In the condition 4, since the power flow is reversed and as the first source 101a is a stronger source, the secondary side of the transformer 102 must be regulated when the voltage values of the secondary side is greater than the predefined voltage band. That is, when the voltage values of the secondary side of the transformer 102 is greater than the predefined voltage band, the first command or the raise command is transmitted by the system 201 to the OLTC. The OLTC controller receives the first command and increases the tap position. Increasing the tap position increases the windings on the primary side, therefore decreasing the voltage on the secondary side. In one embodiment, the number of taps to be increased may be based on the current tap position and the deviation of the secondary side voltage from the predefined threshold value.

In an embodiment, the primary side voltage and the secondary side voltage can be regulated by operating the OLTC to change the winding of the primary side based on the power system operating conditions.

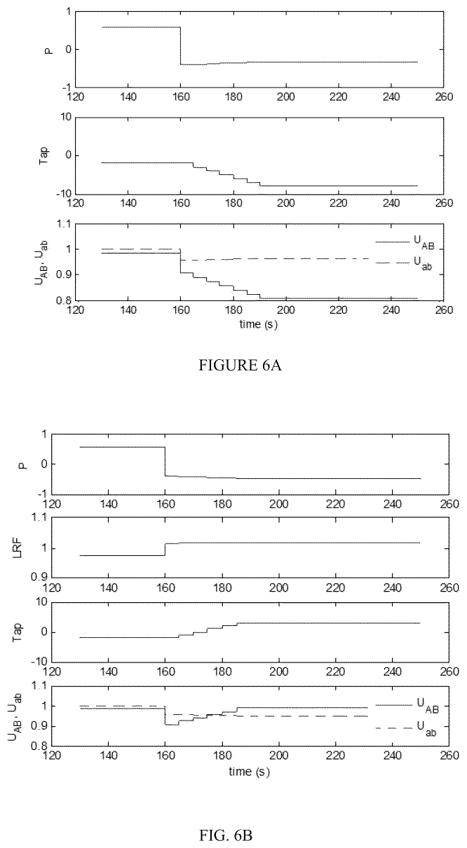

FIGS. 6A and 6B illustrates difference in transformer voltage between conventional system and current system, in accordance with some embodiments of the present disclosure. FIG. 6A illustrates regulation performed by conventional system and FIG. 6B illustrates regulation performed by the proposed system 201. As seen in the FIG. 6A, forward regulation is continued even after power flow direction is reversed. The tap has reached the extreme position, however, the primary voltage value (U_{AB}) value deteriorates even after changing the tap position. Referring to FIG. 6B, LRF is determined to be greater than 1 after the power reversal (LRF>1 indicates source connected to secondary side is stronger than the source connected to primary side). Hence, the tap position is increased thereby increasing the primary voltage.

In an embodiment, the system 201 and method involves simple calculation as only current values and voltage values of the primary and secondary side are considered. Therefore, the system 201 provides fast response and quick actions can be taken by the OLTC. Further, the proposed system 201 and method does not lead to unwanted voltage fluctuations.

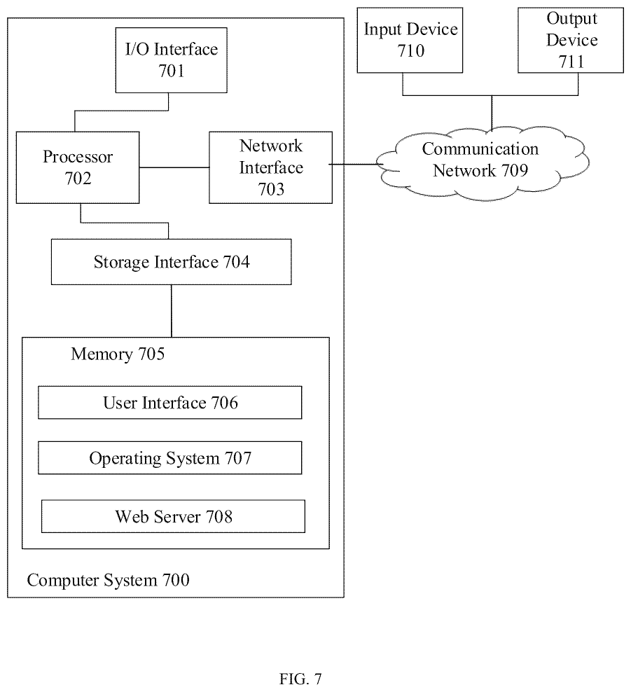

COMPUTER SYSTEM: FIG. 7 illustrates a block diagram of an exemplary computer system 700 for implementing embodiments consistent with the present disclosure. In an embodiment, the computer system 700 may be used to implement the computing system 102. Thus, the computer system 700 may be used to control OLTC in a power system. The computer system 700 may comprise a Central Processing Unit 702 (also referred as “CPU” or “processor”). The processor 702 may comprise at least one data processor. The processor 702 may include specialized processing units such as integrated system (bus) controllers, memory management control units, floating point units, graphics processing units, digital signal processing units, etc.

The processor 702 may be disposed in communication with one or more input/output (I/O) devices (not shown) via I/O interface 701. The I/O interface 701 may employ communication protocols/methods such as, without limitation, audio, analog, digital, mono-aural, RCA, stereo, IEEE (Institute of Electrical and Electronics Engineers)—1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 702.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 701, the computer system 700 may communicate with one or more I/O devices. For example, the input device 710 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 711 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 702 may be disposed in communication with the communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, etc. The communication network 709 may include, without limitation, a direct interconnection, local area network (LAN), wide area network (WAN), wireless network (e.g., using Wireless Application Protocol), the Internet, etc. The network interface 703 may employ connection protocols include, but not limited to, direct connect, Ethernet (e.g., twisted pair 10/100/1000 Base T), transmission control protocol/internet protocol (TCP/IP), token ring, IEEE 702.11a/b/g/n/x, etc.

The communication network 709 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 702 may be disposed in communication with a memory 705 (e.g., RAM, ROM, etc. not shown in FIG. 8) via a storage interface 704. The storage interface 704 may connect to memory 705 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface 706, an operating system 707, web browser 708 etc. In some embodiments, computer system 700 may store user/application data, such as, the data, variables, records, etc., as described in this disclosure. Such databases may be implemented as fault-tolerant, relational, scalable, secure databases such as Oracle® or Sybase®.

The operating system 707 may facilitate resource management and operation of the computer system 700. Examples of operating systems include, without limitation, APPLE MACINTOSH^{R} OS X, UNIX^{R}, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE^{R} IOS™, GOOGLE^{R} ANDROID™, BLACKBERRY^{R} OS, or the like.

In some embodiments, the computer system 700 may implement the web browser 708 stored program component. The web browser 708 may be a hypertext viewing application, for example MICROSOFT^{R} INTERNET EXPLORER™, GOOGLE^{R} CHROME^{TM0}, MOZILLA^{R} FIREFOX™, APPLE^{R} SAFARI™, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX™, DHTML™, ADOBE^{R} FLASH™, JAVASCRIPT™, JAVA™, Application Programming Interfaces (APIs), etc. In some embodiments, the computer system 700 may implement a mail server (not shown in Figure) stored program component. The mail server may be an Internet mail server such as Microsoft Exchange, or the like. The mail server may utilize facilities such as ASP™, ACTIVEX™, ANSI™ C++/C #, MICROSOFT^{R}, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT^{R} exchange, Post Office Protocol (POP), Simple Mail Transfer Protocol (SMTP), or the like. In some embodiments, the computer system 700 may implement a mail client stored program component. The mail client (not shown in Figure) may be a mail viewing application, such as APPLE^{R} MAIL™, MICROSOFT^{R} ENTOURAGE™ MICROSOFT^{R} OUTLOOK™, MOZILLA^{R} THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for effective handling of reverse power flow for an on-load tap changer of a transformer during reverse power flow, the method comprising:
determining a loss ratio factor using voltage and current values for each of a primary side and a secondary side of a transformer when the power flow through a transformer reverses;
determining a relative strength of a first source connected to the primary side and a second source connected to the secondary side of the transformer based on the loss ratio factor; and
transmitting a control signal to an on-load tap changer of the transformer to regulate voltage on the primary side or on the secondary side of the transformer based on the relative strength of the first source and the second source.

2. The method of claim 1, wherein the loss ratio factor is a ratio of the voltage and current values of the secondary side of the transformer to the voltage and current values of the primary side of the transformer.

3. The method of claim 1, wherein determining the relative strength comprises:
determining the strength of the second source is higher than the strength of the first source when a value of the loss ratio factor is greater than 1; and
determining the strength of the first source is higher than the strength of the second source when the value of the loss ratio factor is lesser than 1.

4. The method of claim 1, further comprising determining the voltage and current values, wherein determining comprises:
receiving the voltage and current values for each of the primary side and the secondary side of the transformer by an on-load tap changer controller of the transformer, when the voltage and current values of the primary side and the secondary side of the transformer are measured; or
estimating the voltage and current values for the primary side or the secondary side of the transformer when the voltage and current values of one of the secondary side or primary side of the transformer is measured.

5. The method of claim 1, wherein transmitting the control signal comprises transmitting a first command or transmitting a second command.

6. The method of claim 1, wherein transmitting the control signal to the on-load tap changer is further based on the voltage and current values of each of the primary side and the secondary side of the transformer.

7. The method of claim 1, wherein transmitting the control signal causes the on-load tap changer to increase primary side windings of the transformer when the voltage value on the primary side is less than a predefined voltage band and the loss ratio factor is greater than 1; and wherein transmitting the control signal causes the on-load tap changer to decrease the primary side windings of the transformer when the voltage on the primary side is more than the predefined voltage band and the loss ratio factor is greater than 1.

8. The method of claim 1, wherein transmitting the control signal causes the on-load tap changer to decrease primary side windings of the transformer when the voltage value on the secondary side is less than a predefined voltage band and the loss ratio factor is less than 1; and wherein transmitting the control signal causes the on-load tap changer to increase the primary side windings of the transformer when the voltage on the secondary side is more than the predefined voltage band and the loss ratio factor is less than 1.

9. A system for effective handling of reverse power flow for an on-load tap changer of a transformer, the system comprising:
a memory,
and
one or more processors configured to:
determine a loss ratio factor using voltage and current values for each of a primary side and a secondary side of a transformer when the power flow through a transformer reverses;
determine a relative strength of a first source connected to the primary side and a second source connected to the secondary side of the transformer based on the loss ratio factor; and
transmit a control signal to an on-load tap changer of the transformer to regulate voltage on the primary side or on the secondary side of the transformer based on the relative strength of the first source and the second source.

10. The system of claim 9, wherein the one or more processors are configured to determine the relative strength, wherein the one or more processors:
determine the relative strength of the second source is higher than the strength of the first source when a value of the loss ratio factor is greater than 1; and
determine the relative strength of the first source is higher than the strength of the second source when the value of the loss ratio factor is lesser than 1.

11. The system of claim 9, wherein the one or more processors are configured to determine the voltage and current values, wherein the one or more processors:
receive the voltage and current values for each of the primary side and the secondary side of the transformer by the on-load tap changer of the transformer, when the voltage and current values of the primary side and the secondary side of the transformer are measured; or
estimate the voltage and current values for the primary side or the secondary side of the transformer when the voltage and current values of one of the secondary side or primary side of the transformer is measured.

12. The system of claim 9, wherein the one or more processors are configured to transmit a first command or a second command when transmitting the control signal.

13. The system of claim 9, wherein the one or more processors transmit the control signal to the on-load tap changer to increase primary side windings of the transformer when the voltage value on the primary side is less than a predefined voltage band and the loss ratio factor is greater than 1; and transmit the control signal to the on-load tap changer to decrease the primary side windings of the transformer when the voltage on the primary side is more than the predefined voltage band and the loss ratio factor is greater than 1.

14. The system of claim 9, wherein the one or more processors transmit the control signal to the on-load tap changer to decrease primary side windings of the transformer when the voltage value on the secondary side is less than a predefined voltage band and the loss ratio factor is less than 1; and transmit the control signal to the on-load tap changer to increase the primary side windings of the transformer when the voltage on the secondary side is more than the predefined voltage band and the loss ratio factor is less than 1.
